(19) United States
(12) Patent Application Publication
(10) Pub. No.: US 2026/0200392 A1
(43) Pub. Date: Jul. 16, 2026

(54) DEPLOYABLE VEHICLE TIE-DOWN

(71) Applicant: FORD GLOBAL TECHNOLOGIES, LLC, Dearborn, MI (US)

(72) Inventors: Nayar Zepeda Barragan, Ajusco - Coyoacan (MX); Luis Angel Becerril Cruz, Toluca (MX); Mario Contreras Sosa, Naucalpan (MX); Martin D. Lopez, Oakland, MI (US); David Malinski, Gregory, MI (US); Dan Tannous, Windson, Ontario (CA)

(21) Appl. No.: 19/016,365

(22) Filed: Jan. 10, 2025

(51) Int. Cl. B60P 7/08

(52) U.S. Cl. CPC B60P 7/0807

(57) ABSTRACT

A device may include a vehicle panel having a pocket. A device may include a tie-down configured to transition back-and-forth between a stowed position where the tie-down is positioned within the pocket and a deployed position where the tie-down projects from the pocket away from the vehicle panel, the tie-down including a magnet that holds the tie-down in the stowed position.

### TECHNICAL FIELD

This disclosure relates generally to vehicle tie-downs and, more particularly, to a tie-down having a magnet that helps hold the tie-down in a stowed position within a pocket.

### BACKGROUND

Some vehicles have tie-downs that can be used when transporting cargo, particularly larger items such as kayaks, canoes, bicycles, and other equipment. The tie-downs can help to secure the cargo by providing a spot to secure lines, cords, etc.

### SUMMARY

In some aspects, the techniques described herein relate to a vehicle assembly, including: a vehicle panel having a pocket; and a tie-down configured to transition back-and-forth between a stowed position where the tie-down is positioned within the pocket and a deployed position where the tie-down projects from the pocket away from the vehicle panel, the tie-down including a magnet that holds the tie-down in the stowed position.

In some aspects, the techniques described herein relate to a vehicle assembly, further including a bracket including a body and an arm, wherein the body is arranged inboard of the vehicle panel and the arm extends from the body into the pocket.

In some aspects, the techniques described herein relate to a vehicle assembly, wherein the tie-down is pivotably connected to the arm.

In some aspects, the techniques described herein relate to a vehicle assembly, wherein the bracket is made of a ferrous material.

In some aspects, the techniques described herein relate to a vehicle assembly, wherein the arm has a mating surface that is configured to contact the magnet when the tie-down is in the stowed position.

In some aspects, the techniques described herein relate to a vehicle assembly, further including a coating encapsulating the magnet, the coating configured to resist corrosion of the magnet.

In some aspects, the techniques described herein relate to a vehicle assembly, wherein the coating includes Acrylonitrile Butadiene Styrene (ABS).

In some aspects, the techniques described herein relate to a vehicle assembly, wherein the tie-down includes a recessed area provided by a backwall and a pair of opposed sidewalls, the backwall has a cavity configured to receive the magnet, and a portion of the magnet protrudes from the backwall.

In some aspects, the techniques described herein relate to a vehicle assembly, wherein, when the tie-down is in the stowed position, the backwall and the opposed sidewalls of the tie-down at least partially seal an outer surface of the coating against a mating surface arranged in the pocket.

In some aspects, the techniques described herein relate to a vehicle assembly, wherein, when the tie-down is in the deployed position, the magnet is spaced apart from a mating surface arranged in the pocket.

In some aspects, the techniques described herein relate to a vehicle assembly, wherein the tie-down includes a tie portion for securing cargo to the vehicle when the tie-down is in the deployed position.

In some aspects, the techniques described herein relate to a vehicle assembly, including: a vehicle panel having a pocket; and a tie-down configured to transition back-and-forth between a stowed position where the tie-down is positioned within the pocket and a deployed position where the tie-down projects from the pocket away from the vehicle panel, the tie-down including a magnet encapsulated in a coating configured to resist corrosion of the magnet.

In some aspects, the techniques described herein relate to a vehicle assembly, wherein the tie-down includes a recessed area provided by a backwall and a pair of opposed sidewalls, the backwall has a cavity configured to receive the magnet, and wherein a portion of the magnet protrudes from the backwall.

In some aspects, the techniques described herein relate to a vehicle assembly, further including a bracket including a body and an arm, wherein the body is arranged inboard of the vehicle panel and the arm extends from the body and into the pocket.

In some aspects, the techniques described herein relate to a vehicle assembly, wherein, when the tie-down is in the stowed position, the backwall is aligned with a mating surface of the arm, the opposed sidewalls at least partially cover opposed side surfaces of the arm, and an outer surface of the coating contacts the mating surface.

In some aspects, the techniques described herein relate to a vehicle assembly, wherein the bracket is made of a ferrous material.

In some aspects, the techniques described herein relate to a vehicle assembly wherein the coating includes Acrylonitrile Butadiene Styrene (ABS).

In some aspects, the techniques described herein relate to a vehicle assembly, including: a vehicle panel having a pocket; a bracket including a body and an arm, the body arranged inboard of the vehicle panel, the arm extending from the body and into the pocket, the arm having an angled mating surface; and a tie-down pivotably connected to the arm, the tie-down configured to transition back-and-forth between a stowed position where the tie-down is positioned within the pocket and a deployed position where the tie-down projects from the pocket away from the vehicle panel, the tie-down including a magnet that holds the tie-down in the stowed position, the magnet encapsulated in a coating configured to resist corrosion of the magnet, wherein, when the tie-down is in the stowed position, an outer surface of the coating contacts the angled mating surface.

In some aspects, the techniques described herein relate to a vehicle assembly, wherein the bracket is made of a ferrous material.

In some aspects, the techniques described herein relate to a vehicle assembly, wherein the coating includes Acrylonitrile Butadiene Styrene (ABS).

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1 schematically illustrates a side view of a vehicle carrying cargo according to an exemplary aspect of the present disclosure.

FIG. 2 is a close-up view of a tie-down of the vehicle of FIG. 1 in a stowed position.

FIG. 3 is a close-up view of the tie-down of FIG. 2 in a deployed position.

FIG. 4 is a perspective view of the tie-down of FIG. 3.

FIG. 5 illustrates a magnet of the tie-down of FIGS. 2-4.

### DETAILED DESCRIPTION

This disclosure details exemplary tie-downs for vehicles. The tie-downs can be stowed within a pocket when not in use, and then deployed when needed. The tie-downs include magnets to help hold the tie-downs when stowed. The tie-downs can be deployed and utilized for securing cargo (e.g., kayaks, canoes, bicycles, etc.) to the vehicle for transportation from one location to another. These and other features are discussed in greater detail in the following paragraphs of this detailed description.

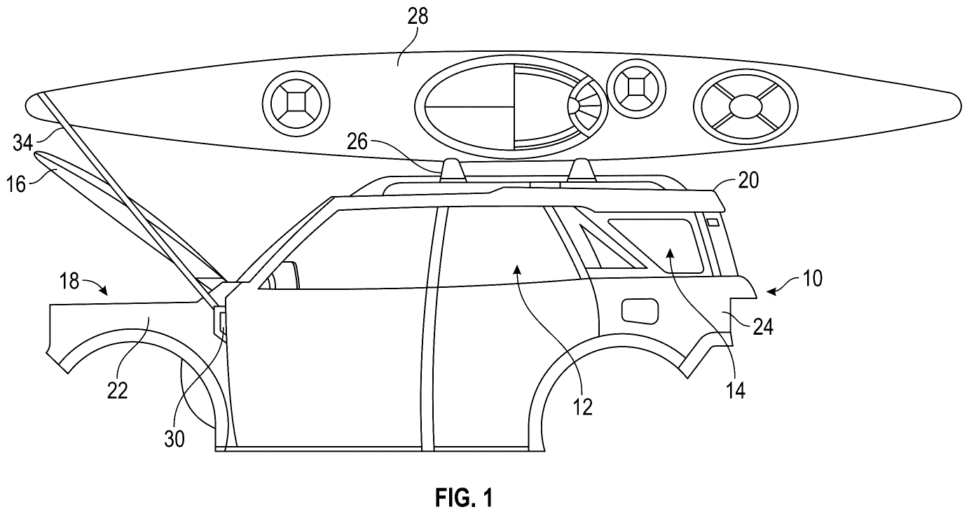

With reference to FIG. 1, a vehicle 10 includes a passenger compartment 12 and a rear storage area 14. A hood 16 is movable between an open position and a closed position to provide access to a compartment 18 of the vehicle 10, such as an engine compartment or a frunk. The vehicle 10 includes various panels. In this example, the panels include a roof panel 20, a front fender panel 22, and a rear fender panel 24.

A mounting system 26 is secured to the roof panel 20. In this example, the mounting system 26 is a rack or rail. The mounting system 26 can be used to support or otherwise carry cargo 28 above the roof panel 20 of the vehicle 10. The cargo 28 can include a kayak, canoe, ladder, surfboard, bicycle, tool box, storage box, etc.

Although the following description is directed to the front fender panel 22 shown on one side of the vehicle 10 illustrated in FIG. 1, it should be understood that the teachings herein are equally applicable to the front fender panel on the opposite side of the vehicle 10. Additionally, the teachings herein could also be applicable to the rear fender panels of the vehicle 10.

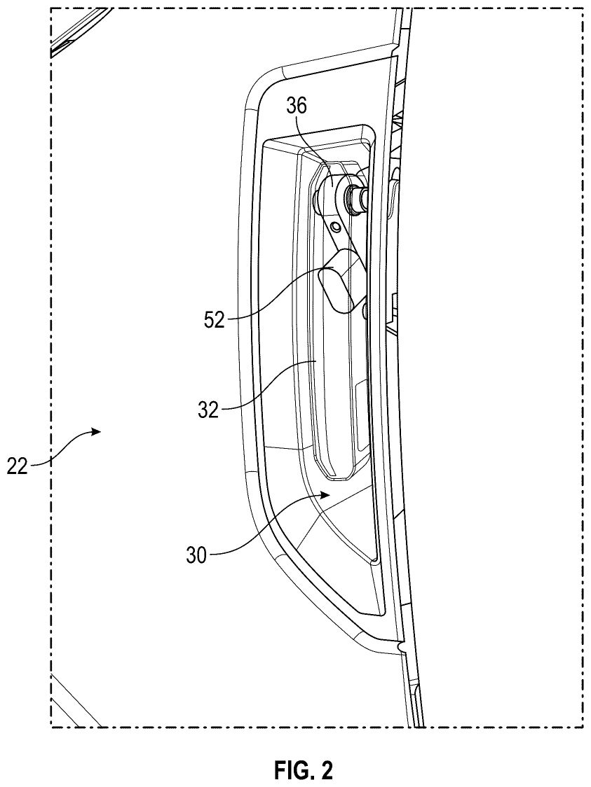

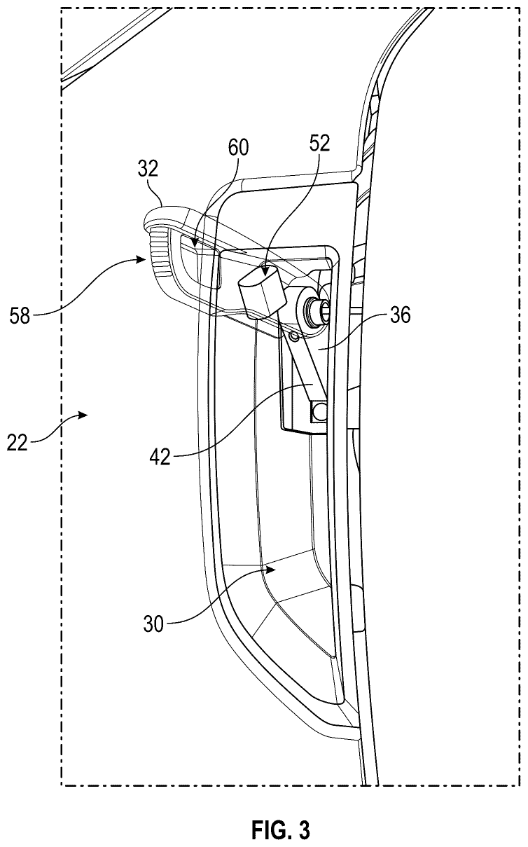

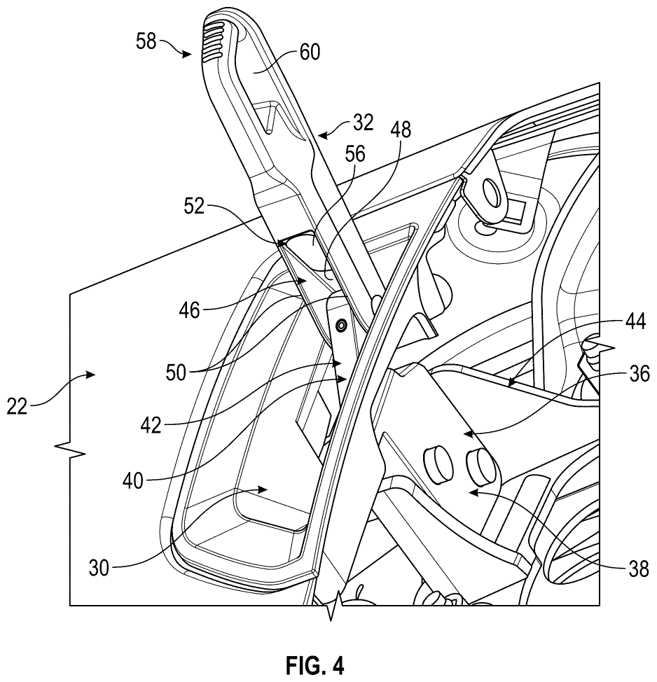

Referring now to FIGS. 2-4 with continuing reference to FIG. 1, the front fender panel 22 includes a pocket 30 that accommodates a tie-down 32. The tie-down 32 is configured to transition back-and-forth between a stowed position (FIG. 2) and a deployed position (FIGS. 3 and 4).

When in the stowed position, the tie-down 32 is contained within the pocket 30, and is generally flush with an outboard side of the front fender panel 22 such that the tie-down 32 does not project or otherwise protrude from the pocket 30.

When in the deployed position, the tie-down 32 projects from the pocket 30 away from the front fender panel 22. As discussed further below, when in the deployed position, the tie-down 32 can serve an anchor point for a tie member 34, such as a rope, strap, cord, cable, etc., to secure the cargo 28 to the roof panel 20 of the vehicle 10 (FIG. 1).

Referring to FIG. 4, a bracket 36 is provided to secure the tie-down 32 to the front fender panel 22. The bracket 36 includes a body 38 and an arm 40. The body 38 is arranged inboard of the front fender panel 22. The arm 40 extends from the body 38 and into the pocket 30 of the front fender panel 22.

In this example, the arm 40 extends from the body 38 at an angle and provides a mating surface 42. The mating surface 42 is shaped at an angle to interface with one or more corresponding surfaces of the tie-down 32. The bracket 36 is secured to a mounting structure 44. The mounting structure 44 is configured to support the bracket 36 and the tie-down 32 when the tie-down 32 is loaded and used to secure the cargo 28 to the vehicle 10.

In an embodiment, the tie-down 32 is made of a plastic material and the bracket 36 and the mounting structure 44 are made of a ferrous (or magnetic) material.

The tie-down 32 is pivotably connected to the arm 40 of the bracket 36. The arm 40 provides a pivot point that allows the tie-down 32 to transition back-and-forth between the stowed position and the deployed position.

The tie-down 32 can include a recessed area 46 on a surface of the tie-down 32 that is disposed within the pocket 30 when the tie-down 32 is in the stowed position. The recessed area 46 is provided by a backwall 48 and a pair of sidewalls 50 which serve to at least partially cover or otherwise enclose part of the arm 40 of the bracket 36 when the tie-down 32 is in the stowed position. The backwall 48 is angled or otherwise sloped to match the angle of the mating surface 42 of the arm 40. The opposed sidewalls 50 extend from the backwall 48 and, in this example, run parallel to opposed side surfaces of the arm 40. This facilitates proper alignment when the tie-down 32 is moved to the stowed position.

The tie-down 32 includes a magnet 52 within the recessed area 46. In this example, the magnet 52 is received within a cavity formed in the backwall 48. The magnet 52 could be molded as part of the backwall 48 or affixed to the backwall 48 in a way that integrates the magnet 52 into the tie-down 32. At least a portion of the magnet 52 protrudes from the backwall 48 and extends into the recessed area 46.

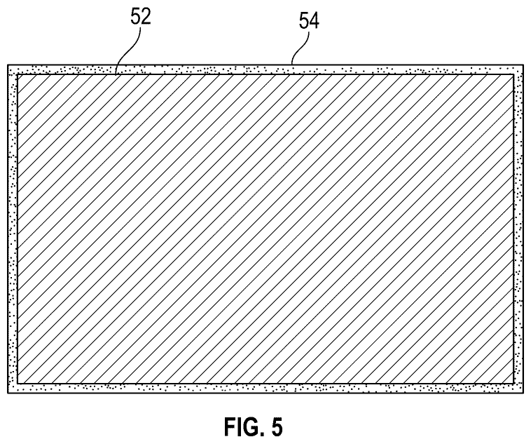

Referring to FIG. 5, the magnet 52 is encapsulated in a coating 54. The coating 54 is configured to resist corrosion of the magnet 52. The coating 54 fully encapsulates the magnet 52 (i.e., the coating 54 covers all external surfaces of the magnet 52) to protect the underneath material of the magnet 52 from external elements (e.g., moisture, salts, chemicals, etc.). The coating 54 can comprise Acrylonitrile Butadiene Styrene (ABS).

Referring again to FIGS. 2-4 with continuing reference to FIG. 5, the magnet 52 is configured to help hold the tie-down 32 in the stowed position. When the tie-down 32 is in the stowed position, the recessed area 46 covers or otherwise encloses part of the arm 40 of the bracket 36, and the backwall 48 is aligned with the angle of the mating surface 42 of the arm 40. The sidewalls 50 can block the tie-down 32 from shifting laterally. An outer surface 56 of the coating 54 contacts the mating surface 42 when the tie-down 32 is in the stowed position. The magnetic field of the magnet 52 interacts directly with the magnetic field of the bracket 36 to establish a magnetic bond sufficient to hold the tie-down 32 in the stowed position. In an embodiment, the magnetic bond establishes an attractive force from 1 to 3 Newtons. The tie-down 32 is held in the stowed position until an external force is applied that is sufficient to overcome the magnetic bond and move the tie-down 32 to the deployed position. When the tie-down 32 is in the deployed position, the magnet 52 is spaced apart from the mating surface 42.

The tie-down 32 can include a tie portion 58 for use when securing the cargo 28 to the vehicle 10. The tie portion 58 can include an opening 60 to hold the tie member 34 securely.

When the tie-down 32 is in the deployed position, the tie portion 58 extends outwardly from the front fender panel 22 to position the opening 60 for use as an anchor point. A user can loop or otherwise thread the tie member 34 through the opening 60 and secure it with knots, clamps, hooks, etc. to hold the cargo 28 in place on the roof panel 20.

The tie member 34 can hold the tie-down 32 in the deployed position. Once the tie member 34 is detached and no external force holds the tie-down 32 in the deployed position, the tie-down 32 can pivot back into the pocket 30. This pivoting can be gravity-assisted movement that returns the tie-down 32 to the stowed position without additional mechanisms like springs or locking devices to move it back in place.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a vehicle panel having a pocket; and
a tie-down configured to transition back-and-forth between a stowed position where the tie-down is positioned within the pocket and a deployed position where the tie-down projects from the pocket away from the vehicle panel, the tie-down including a magnet that holds the tie-down in the stowed position.

2. The vehicle assembly as recited in claim 1, further comprising a bracket including a body and an arm, wherein the body is arranged inboard of the vehicle panel and the arm extends from the body into the pocket.

3. The vehicle assembly as recited in claim 2, wherein the tie-down is pivotably connected to the arm.

4. The vehicle assembly as recited in claim 2, wherein the bracket is made of a ferrous material.

5. The vehicle assembly as recited in claim 4, wherein the arm has a mating surface that is configured to contact the magnet when the tie-down is in the stowed position.

6. The vehicle assembly as recited in claim 1, further comprising a coating encapsulating the magnet, the coating configured to resist corrosion of the magnet.

7. The vehicle assembly as recited in claim 6, wherein the coating comprises Acrylonitrile Butadiene Styrene (ABS).

8. The vehicle assembly as recited in claim 6, wherein the tie-down includes a recessed area provided by a backwall and a pair of opposed sidewalls, the backwall has a cavity configured to receive the magnet, and a portion of the magnet protrudes from the backwall.

9. The vehicle assembly as recited in claim 8, wherein, when the tie-down is in the stowed position, the backwall and the opposed sidewalls of the tie-down at least partially seal an outer surface of the coating against a mating surface arranged in the pocket.

10. The vehicle assembly as recited in claim 8, wherein, when the tie-down is in the deployed position, the magnet is spaced apart from a mating surface arranged in the pocket.

11. The vehicle assembly as recited in claim 1, wherein the tie-down includes a tie portion for securing cargo to the vehicle when the tie-down is in the deployed position.

12. A vehicle assembly, comprising:
a vehicle panel having a pocket; and
a tie-down configured to transition back-and-forth between a stowed position where the tie-down is positioned within the pocket and a deployed position where the tie-down projects from the pocket away from the vehicle panel, the tie-down including a magnet encapsulated in a coating configured to resist corrosion of the magnet.

13. The vehicle assembly as recited in claim 12, wherein the tie-down includes a recessed area provided by a backwall and a pair of opposed sidewalls, the backwall has a cavity configured to receive the magnet, and wherein a portion of the magnet protrudes from the backwall.

14. The vehicle assembly as recited in claim 13, further comprising a bracket including a body and an arm, wherein the body is arranged inboard of the vehicle panel and the arm extends from the body and into the pocket.

15. The vehicle assembly as recited in claim 14, wherein, when the tie-down is in the stowed position, the backwall is aligned with a mating surface of the arm, the opposed sidewalls at least partially cover opposed side surfaces of the arm, and an outer surface of the coating contacts the mating surface.

16. The vehicle assembly as recited in claim 14, wherein the bracket is made of a ferrous material.

17. The vehicle assembly as recited in claim 12 wherein the coating comprises Acrylonitrile Butadiene Styrene (ABS).

18. A vehicle assembly, comprising:
a vehicle panel having a pocket;
a bracket including a body and an arm, the body arranged inboard of the vehicle panel, the arm extending from the body and into the pocket, the arm having an angled mating surface; and
a tie-down pivotably connected to the arm, the tie-down configured to transition back-and-forth between a stowed position where the tie-down is positioned within the pocket and a deployed position where the tie-down projects from the pocket away from the vehicle panel, the tie-down including a magnet that holds the tie-down in the stowed position, the magnet encapsulated in a coating configured to resist corrosion of the magnet,
wherein, when the tie-down is in the stowed position, an outer surface of the coating contacts the angled mating surface.

19. The vehicle assembly as recited in claim 18, wherein the bracket is made of a ferrous material.

20. The vehicle assembly as recited in claim 18, wherein the coating comprises Acrylonitrile Butadiene Styrene (ABS).
